(19) United States
(12) Patent Application Publication
(10) Pub. No.: US 2016/0274396 A1
(43) Pub. Date: Sep. 22, 2016

(54) DISPLAY PANEL AND MANUFACTURE METHOD THEREOF

(71) Applicant: SHENZHEN CHINA STAR OPTOELECTRONICS TECHNOLOGY CO., LTD., Shenzhen, Guangdong (CN)

(72) Inventor: Chenglei NIE, Shenzhen, Guangdong (CN)

(73) Assignee: Shenzhen China Star Optoelectronics Technology Co., Ltd., Shenzhen, Guangdong (CN)

(21) Appl. No.: 14/407,454

(22) PCT Filed: Nov. 21, 2014
(86) PCT No.: PCT/CN2014/091870

§ 371 Date: Dec. 11, 2014

(30) Foreign Application Priority Data
Nov. 14, 2014 (CN) 201410650091.3

(51) Int. Cl. G02F 1/1333; G02F 1/1339

(52) U.S. Cl. CPC G02F 1/13338; G02F 1/1339; G02F 2001/133388

(57) ABSTRACT

The present invention discloses a display panel and a manufacture method thereof. The display panel comprises a first substrate, a second substrate and a middle layer, sandwiched between the first substrate and the second substrate. An opening penetrating at least one of the first substrate and the second substrate is formed in an active area of at least one of the first substrate and the second substrate. According to the aforesaid arrangement, the present invention is capable of reserving space to add new functions for the active area of the display panel.

### FIELD OF THE INVENTION

The present invention relates to a liquid crystal display field, and more particularly to a display panel and a manufacture method thereof.

### BACKGROUND OF THE INVENTION

With the development of the technology, the computer, the cell phone, the television with displays have become the indispensable electronic products in the people's daily lives. Generally, some functional elements, such as push buttons or sensor may be positioned at the periphery of the displayers of these electronic products. However, these functional elements are all positioned outside the active areas of the displays of the electronic products in prior arts. The occupied area of the functional element itself is not large but restricts the possible area of the display of the electronic product for showing images. Moreover, the function of the active area can be too monotonous.

### SUMMARY OF THE INVENTION

The technical issue to be solve by the present invention is to provide a display panel and a manufacture method thereof which are capable of reserving space to add new functions for the active area of the display panel

For solving the aforesaid technical issue , the technical solution employed by the present invention is: to provide a display panel, comprising:

a first substrate;

a second substrate, oppositely positioned to the first substrate;

a middle layer, sandwiched between the first substrate and the second substrate;

wherein an opening penetrating at least one of the first substrate and the second substrate is formed in an active area of at least one of the first substrate and the second substrate;

the opening extends to the middle layer or the opening penetrates the display panel.

Seal is positioned between the first substrate and the second substrate in accordance with a position of the opening to encircle the opening.

A dimension of a cross section of the opening on the first substrate and a dimension of a cross section of the opening on the second substrate are different.

A touch screen is located at a side of showing images of the display panel, and the opening adjacent to the side of showing images of the display panel extends and penetrates the touch screen.

A cross section of the opening is circular, rectangle or triangle.

For solving the aforesaid technical issue, another technical solution employed by the present invention is: to provide a display panel, comprising:

a first substrate;

a second substrate, oppositely positioned to the first substrate;

a middle layer, sandwiched between the first substrate and the second substrate;

wherein an opening penetrating at least one of the first substrate and the second substrate is formed in an active area of at least one of the first substrate and the second substrate.

The opening extends to the middle layer.

The opening penetrates the display panel.

Seal is positioned between the first substrate and the second substrate in accordance with a position of the opening to encircle the opening.

A dimension of a cross section of the opening on the first substrate and a dimension of a cross section of the opening on the second substrate are different.

A touch screen is located at a side of showing images of the display panel, and the opening adjacent to the side of showing images of the display panel extends and penetrates the touch screen.

A cross section of the opening is circular, rectangle or triangle.

The benefits of the present invention are: different from the prior arts, the present invention forms an opening penetrating at least one of the first substrate and the second substrate in an active area of at least one of the first substrate and the second substrate. The functional element, such as push button, sensor, camera, et cetera can be installed at the opening. The present invention can position the opening in the active area of the display panel. Accordingly, the active area of the display panel can extend to frame part where the functional element is installed in prior art. Therefore, the present invention can reserve space to add new functions for the active area of the display panel.

### BRIEF DESCRIPTION OF THE DRAWINGS

FIG. 1 is a structural diagram of a display panel according to one embodiment of the present invention;

FIG. 2 is a structural diagram of a display panel according to another embodiment of the present invention;

FIG. 3 is a structural diagram of a display panel according to another embodiment of the present invention;

FIG. 4 is a flowchart of a manufacture method of a display panel according to the present invention.

### DETAILED DESCRIPTION OF PREFERRED EMBODIMENTS

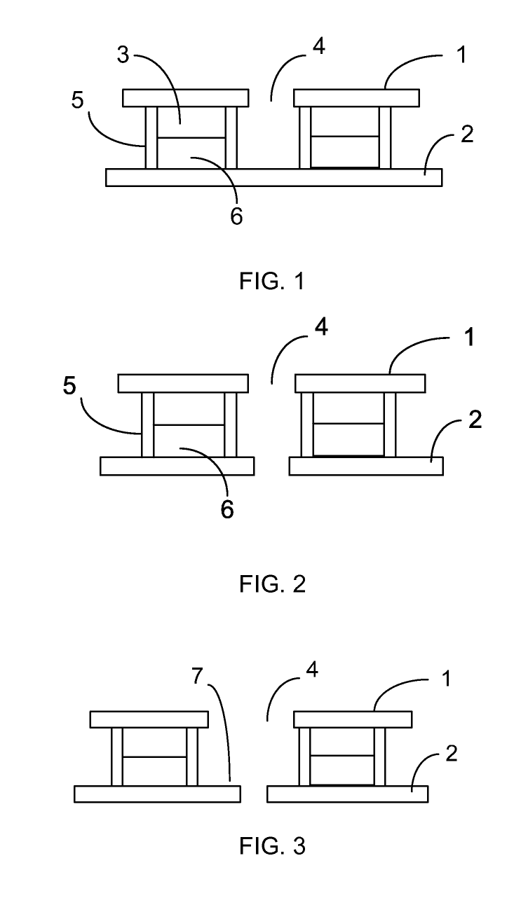

As shown in FIG. 1, the present invention provides a display panel, comprising a first substrate 1, a second substrate 2 and a middle layer 3. The first substrate 1 and the second substrate 2 are oppositely positioned. The middle layer 3 is sandwiched between the first substrate 1 and the second substrate 2. In general, the first substrate 1 and the second substrate 2 are rectangle structures. One of them is employed for showing images. The other comprises drive circuit formed thereon. The middle layer 3 is packaged between the first substrate 1 and the second substrate 2 with seal 5. The middle layer 3 can be filled with liquid crystal.

An opening 4 penetrating at least one of the first substrate 1 and the second substrate 2 is formed in an active area of at least one of the first substrate 1 and the second substrate 2. In another word, the opening 4 is in an active area of the first substrate 1 or the second substrate 2. The opening 4 penetrates the first substrate 1 or the second substrate 2 corresponding thereto. The opening 4 can be installed with a functional element. The appearance and the specific position on the first substrate 1 or the second substrate 2 are determined depending on the requirements of the installed functional element.

Different from the prior arts, the present invention forms an opening penetrating at least one of the first substrate 1 and the second substrate 2 in an active area of at least one of the first substrate 1 and the second substrate 2. The functional element, such as push button, sensor, camera, et cetera can be installed at the opening 4. The present invention can position the opening 4 in the active area of the display panel. Accordingly, the active area of the display panel can extend to frame part where the functional element is installed in prior art. Therefore, the present invention can reserve space to add new functions for the active area of the display panel. Meanwhile, the frame part in prior art can be added in the active area in advance. By positioning the functional element installed in frame part in the active area, the area of active area of the display panel can be increased.

The opening 4 extends to the middle layer 3. Under circumstance that the installed functional element requires, the opening 4 extends to the middle layer 3 corresponding thereto for installing the functional element at the middle layer 3. Meanwhile, the middle layer 3 corresponding to the opening 4 does not function for display because the first substrate 1 or the second substrate 2 misses a part where the opening 4 is positioned. In the implement of the present invention, as the opening 4 extends to the middle layer 3, the liquid crystal 6 which the middle layer 3 previously needs to be filled can be saved now at the opening 4.

As shown in FIG. 2, the opening 4 penetrates the display panel. That is, the opening 4 extends to the middle layer 3 and keeps extending to penetrate the first substrate 1 or the second substrate 2 corresponding thereto to form the opening 4 penetrating the entire display panel. Accordingly, a function element which requires connecting the front side and the back side of the display panel can be installed at such opening 4.

Seal 5 is positioned between the first substrate 1 and the second substrate 2 in accordance with a position of the opening 4 to encircle the opening 4. After packaging the liquid crystal 6 of middle layer 3 between the first substrate 1 and the second substrate 2 with the seal 5 and sealing the liquid crystal 6 of middle layer 3 at the same time, the opening 4 can be installed with the functional element.

As shown in FIG. 3, as the opening 4 penetrates the display panel, a dimension of a cross section of the opening 4 on the first substrate 1 and a dimension of a cross section of the opening 4 on the second substrate 2 can be determined to be different. The opening 4 does not have to be a standard column shape. The area of the opening 4 at the first substrate 1 can be larger than the area of the opening 4 at the second substrate 2. A mesa 7 will be preserved at the inner side of the substrate which the opening 4 is smaller to be suitable for installing the functional element. Meanwhile, the appearances of the two ends of the opening 4 can be different.

A touch screen is located at a side of showing images of the display panel, and the opening 4 adjacent to the side of showing images of the display panel extends and penetrates the touch screen. In the implement of the present invention, as the display panel possesses touch function, the opening 4 is positioned in the active area of the display panel and the some functional element cooperating with the touch screen is installed at the opening 4, the function of the display panel possessing the touch function can be expanded.

A cross section of the opening 4 is circular, rectangle or triangle. The opening 4 as a whole can be a cylinder, a cone, a prism or any other cubic appearances. The specific condition can be determined based on the requirements of the installed functional element.

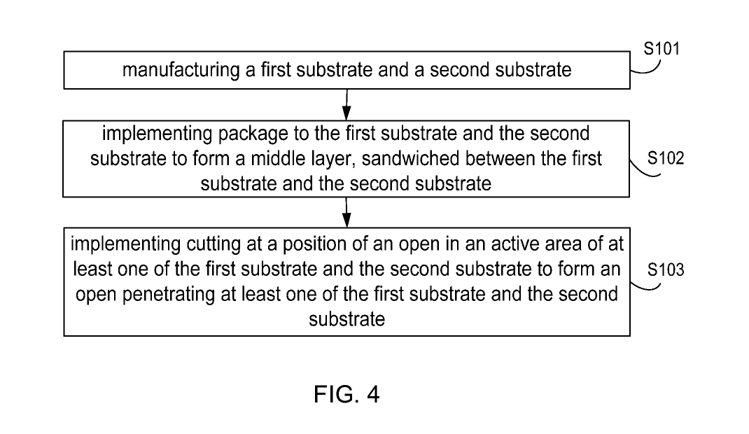

As shown in FIG. 4, another embodiment of the present invention provides a manufacture method of a display panel for manufacturing the display panel in the aforesaid embodiment. The method comprises:

Step S101, manufacturing a first substrate and a second substrate;

Regular procedures in this field can be employed for forming the first substrate and the second substrate by deposition and et cetera.

Step S102, implementing package to the first substrate and the second substrate to form a middle layer, sandwiched between the first substrate and the second substrate;

The first substrate and the second substrate are oppositely positioned. Then, the peripheries of the first substrate and the second substrate are packaged with seal to form a middle layer between the first substrate and the second substrate.

Step S103, implementing cutting at a position of an opening in an active area of at least one of the first substrate and the second substrate to form an opening penetrating at least one of the first substrate and the second substrate;

A regular cutting in this field, such as laser cutting can be employed to implement cutting to the first substrate and the second substrate to form an opening penetrating the first substrate and the second substrate in the active area of the first substrate and the second substrate; for saving the raw material cost and the cutting cost, as manufacturing the first substrate and the second substrate in the Step S101, the deposition can be not implemented to the glass substrate at the position of the opening. Thereby, as implementing cutting, the opening penetrating the first substrate and the second substrate will be accomplished by cutting the glass substrate at the position of the opening.

Different from the prior arts, the present invention forms an opening penetrating at least one of the first substrate and the second substrate in an active area of at least one of the first substrate and the second substrate. The functional element, such as push button, sensor, camera, et cetera can be installed at the opening. The present invention can position the opening in the active area of the display panel. Accordingly, the active area of the display panel can extend to frame part where the functional element is installed in prior art. Therefore, the present invention can reserve space to add new functions for the active area of the display panel. Meanwhile, the frame part in prior art can be added in the active area in advance. By positioning the functional element installed in frame part in the active area, the area of active area of the display panel can be increased.

In the Step S102, the step of implementing package to the first substrate and the second substrate comprises:

implementing package between the first substrate and the second substrate in accordance with the position of the opening with a seal frame as implementing package to the first substrate and the second substrate to make the seal encircle the opening when the opening extends to the middle layer or the opening penetrates the display panel.

As the opening penetrates the display panel, a dimension of a cross section of the opening on the first substrate and a dimension of a cross section of the opening on the second substrate can be determined to be different. The opening does not have to be a standard column shape. The area of the opening at the first substrate can be larger than the area of the opening at the second substrate. A mesa will be preserved at the inner side of the substrate which the opening is smaller to be suitable for installing the functional element. Meanwhile, the appearances of the two ends of the opening can be different.

A touch screen is located at a side of showing images of the display panel, and the opening adjacent to the side of showing images of the display panel extends and penetrates the touch screen. In the implement of the present invention, as the display panel possesses touch function, the opening is positioned in the active area of the display panel and the some functional element cooperating with the touch screen is installed at the opening, the function of the display panel possessing the touch function can be expanded.

A cross section of the opening is circular, rectangle or triangle. The opening as a whole can be a cylinder, a cone, a prism or any other cubic appearances. The specific condition can be determined based on the requirements of the installed functional element.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A display panel, comprising:
a first substrate;
a second substrate, oppositely positioned to the first substrate;
a middle layer, sandwiched between the first substrate and the second substrate;
wherein an opening penetrating at least one of the first substrate and the second substrate is formed in an active area of at least one of the first substrate and the second substrate;
the opening extends to the middle layer or the opening penetrates the display panel.

2. The display panel according to claim 1, wherein seal is positioned between the first substrate and the second substrate in accordance with a position of the opening to encircle the opening.

3. The display panel according to claim 1, wherein a dimension of a cross section of the opening on the first substrate and a dimension of a cross section of the opening on the second substrate are different.

4. The display panel according to claim 1, wherein a touch screen is located at a side of showing images of the display panel, and the opening adjacent to the side of showing images of the display panel extends and penetrates the touch screen.

5. The display panel according to claim 1, wherein a cross section of the opening is circular, rectangle or triangle.

6. A manufacture method of a display panel, comprising:
manufacturing a first substrate and a second substrate;
implementing package to the first substrate and the second substrate to form a middle layer, sandwiched between the first substrate and the second substrate;
implementing cutting at a position of an opening in an active area of at least one of the first substrate and the second substrate to form an opening penetrating at least one of the first substrate and the second substrate.

7. The method according to claim 6, wherein the step of implementing package to the first substrate and the second substrate comprises:
implementing package between the first substrate and the second substrate in accordance with the position of the opening with a seal frame as implementing package to the first substrate and the second substrate to make the seal encircle the opening when the opening extends to the middle layer or the opening penetrates the display panel.

8. The method according to claim 6, wherein a cross section of the opening is circular, rectangle or triangle.

9. A display panel, comprising:
a first substrate;
a second substrate, oppositely positioned to the first substrate;
a middle layer, sandwiched between the first substrate and the second substrate;
wherein an opening penetrating at least one of the first substrate and the second substrate is formed in an active area of at least one of the first substrate and the second substrate.

10. The display panel according to claim 9, wherein the opening extends to the middle layer.

11. The display panel according to claim 9, wherein the opening penetrates the display panel.

12. The display panel according to claim 10, wherein seal is positioned between the first substrate and the second substrate in accordance with a position of the opening to encircle the opening.

13. The display panel according to claim 11, wherein a dimension of a cross section of the opening on the first substrate and a dimension of a cross section of the opening on the second substrate are different.

14. The display panel according to claim 9, wherein a touch screen is located at a side of showing images of the display panel, and the opening adjacent to the side of showing images of the display panel extends and penetrates the touch screen.

15. The display panel according to claim 9, wherein a cross section of the opening is circular, rectangle or triangle.

16. The display panel according to claim 11, wherein seal is positioned between the first substrate and the second substrate in accordance with a position of the opening to encircle the opening.
